(19) United States
(12) Patent Application Publication
(10) Pub. No.: US 2017/0311570 A1
(43) Pub. Date: Nov. 2, 2017

(54) PET WASTE REMOVAL SYSTEM AND METHOD

(71) Applicant: Kenneth Goldsmith, Edison, NJ (US)

(72) Inventor: Kenneth Goldsmith, Edison, NJ (US)

(21) Appl. No.: 15/583,976

(22) Filed: May 1, 2017

Related U.S. Application Data
(60) Provisional application No. 62/330,013, filed on Apr. 29, 2016.

(51) Int. Cl. A01K 23/00

(52) U.S. Cl. CPC A01K 23/005

(57) ABSTRACT

A device for disposal of waste material includes a handle, a shovel blade, and a catch. The device for disposal of waste material is useful for catching and removing pet waste material as the pet is defecating before falling to ground. The device includes a telescoping handle which allows a user to extend the device to the desired height for comfort. The device uses a group of clips to secure a pet waste bag to the catch which allows for easy installation. When the pet defecates a user simply pushes the catch and shovel blade under the pet to catch the waste, then the user may remove the clips and dispose of the used pet waste bag.

### CROSS-REFERENCE TO RELATED APPLICATION

The present application is related to and claims priority to U.S. Provisional Patent Application No. 62/330,013 filed Apr. 29, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of waste disposal and more specifically relates to waste removal tools.

### 2. Description of Related Art

While on a walk with their pet, a pet owner typically carries a plastic bag or pet waste bag capable of retrieving and holding pet waste for removal. Having to bend over and physically pick up the pet waste can be a painful and unsanitary process for some people. Some pet owners may completely abandon the idea of picking up their pet waste and cause parts of the community become unsanitary. A suitable solution is desired.

U.S. Pat. No. 7,090,268 to Setsuko Borman relates to a dog waste catcher and holder. The described dog waste catcher and holder includes a dog waste catcher and holder which is a very simple, light-weight and economical portable device designed to catch and hold a dog's droppings before they fall on the ground or grass. It is carried by a dog's owner or caretaker while he or she walks the dog. This is a device comprised of a loop shaped device to hold a plastic bag, a carrying rod of which one end is attached to the loop shaped device, a securing device such as a bracket to attach the loop shaped device to one end of the carrying rod, and a plastic bag, preferably a plastic bag such as a grocery bag, etc. placed inside the loop shaped device with its upper portion folded over the loop and its ends tied to the rod where the loop shaped device is attached. As soon as the dog shows the motion to excrete, this device can be placed under the dog's bottom and catches the waste in the plastic bag as it excretes. Once the dog has finished excreting, the plastic bag is removed and discarded. This is a very simple and sanitary way of catching and discarding the dog waste

### BRIEF SUMMARY OF THE INVENTION

In view of the foregoing disadvantages inherent in the known waste removal tools art, the present disclosure provides a novel pet waste removal system. The general purpose of the present disclosure, which will be described subsequently in greater detail, is to provide a device for the disposal of waste material. A device for disposal of waste material is disclosed herein. The device for disposal of waste material includes a handle, a shovel blade, and a catch.

According to another embodiment, a device for disposal of waste material is also disclosed herein. The device for disposal of waste material includes a handle, a shovel blade, and a catch. According to this embodiment, the a handle having a grip, the grip includes finger grooves configured to allow the user to grasp firmly, a shovel blade coupled to the handle, the handle includes a hinge pivotably coupling to the catch; the handle tilts back thirty degrees, and the hinge is parallel to the catch permitting the telescoping handle to move backward and alternatively forward in relation to the shovel blade. The handle includes a telescoping member; the telescoping member includes a lock configured to secure the telescoping handle in an extended position. As designed, the telescoping member is collapsible into a stowed configuration. The shovel blade includes a scooping edge (with a ramped portion); and a center aperture.

The shovel blade includes a back wall; the back wall includes a fastening lip, further comprising a plurality of bag clips configured to clip the disposable bag to the fastening lip. As such it is configured to hold open and secure a disposable bag to the device during use opposite the scooping edge, and at least partially around the center aperture. The disposable bag is further configured to removably attach to the back wall; the shovel blade configured to direct the waste material from the scooping edge through the center aperture when scooped.

A catch is preferably coupled to the center aperture; the catch includes the disposable bag configured to attach to the shovel blade. The shovel blade includes tines configured to help scoop debris into the catch, and also is configured to receive the scooped waste material and retain the scooped waste material when passed through the center aperture.

According to another embodiment, a method of using the pet waste removal system for the disposal of waste material is also disclosed herein. The method of using the pet waste removal system for the disposal of waste material includes placing a disposable bag in the device, extending the device, catching waste material, removing disposable bag from device; and disposing of the used disposable bag.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pet waste removal system, constructed and operative according to the teachings of the present disclosure.

FIG. 1 is a side view of the pet waste removal system during an ‘in-use’ condition, according to an embodiment of the disclosure.

FIG. 2A is a perspective view of the pet waste removal system of FIG. 1, according to an embodiment of the present disclosure.

FIG. 2B is a perspective view of the pet waste removal system of FIG. 1, according to an embodiment of the present disclosure.

FIG. 3A is a perspective view of the pet waste removal system of FIG. 1, according to an embodiment of the present disclosure.

FIG. 3B is another perspective view of the pet waste removal system of FIG. 1, according to an embodiment of the present disclosure.

FIG. 4 is a perspective view of the pet waste removal system of FIG. 1, according to an embodiment of the present disclosure.

FIG. 5 is a flow diagram illustrating a method of using the pet waste removal system for the disposal of waste material, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a waste removal tools and more particularly to a pet waste removal system as used to improve the catching and removing pet waste material as the pet is defecating before the waste falls to the ground.

Generally, disclosed is a dog waste pickup device. When a dog defecates, the waste will fall into a bag which is held on the ground in the device. This will provide a better and more sanitary waste removal system. The system has a handle about three to four feet in length. The mechanism should have quick release clips which is used to hold a plastic pet waste bag in place. After use, the clips are released and the bag drops off into the appropriate receptacle. When the owner takes a pet for a walk to relieve itself, he/she simply places the system under the pet's hind quarters to catch the falling waste.

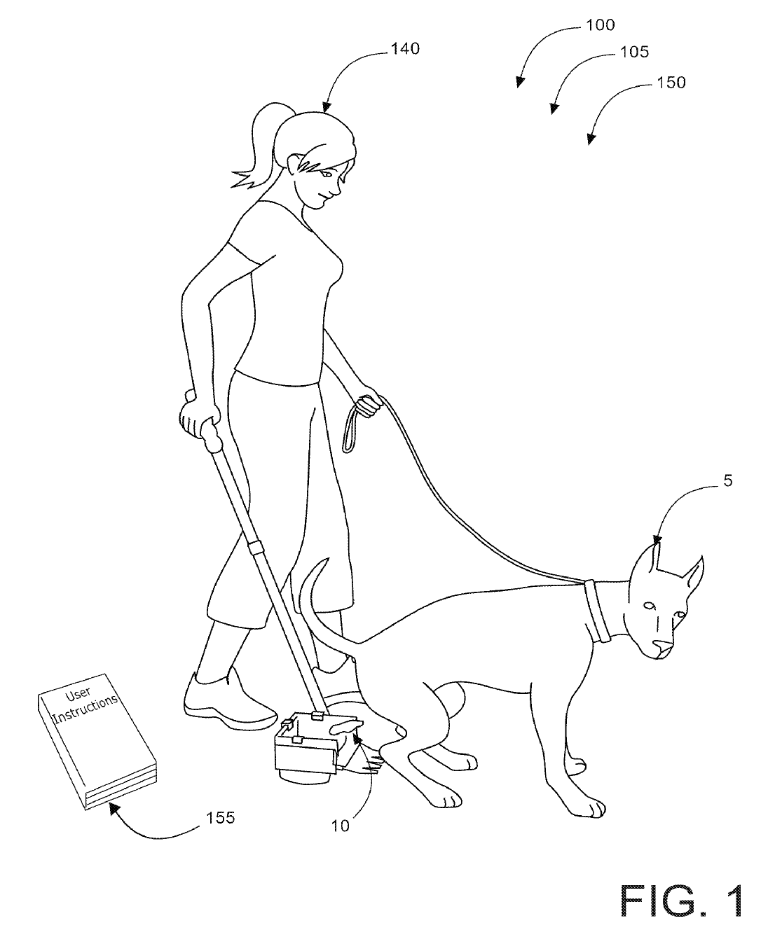

Referring now more specifically to the drawings by numerals of reference, there is shown in FIGS. 1-4, various views of a device for disposal of waste material 100. FIG. 1 shows a device for disposal of waste material 100 during an ‘in-use’ condition 150, according to an embodiment of the present disclosure. Here, the device for disposal of waste material 100 may be beneficial for use by a user 140 for catching and removing pet waste material 10 as the pet 5 is defecating before falling to ground. As illustrated, the device for disposal of waste material 100 may include a handle 110 having a grip 115, a shovel blade 120 coupled to the handle 110 having a center aperture 125, and a catch 130 attached to the center aperture 125.

According to one embodiment, the device for disposal of waste material 100 may be arranged as a kit 105. In particular, the device for disposal of waste material 100 may further include a set of instructions 155. The instructions 155 may detail functional relationships in relation to the structure of the device for disposal of waste material 100 (such that the device for disposal of waste material 100 can be used, maintained, or the like, in a preferred manner).

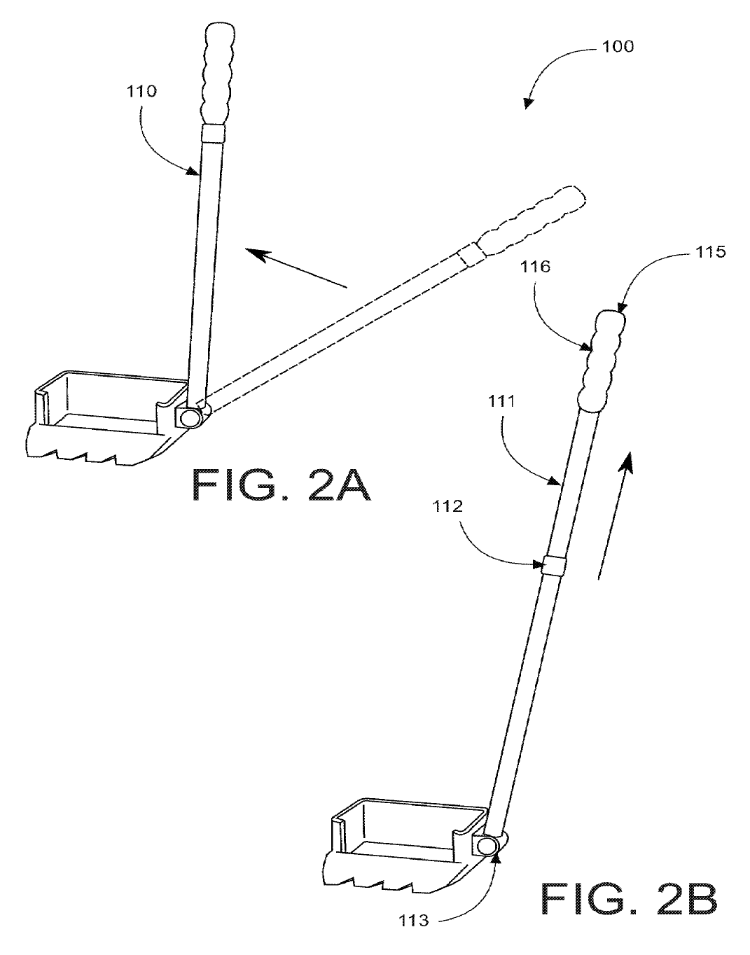

FIG. 2A-2B shows the device for disposal of waste material 100 of FIG. 1, according to an embodiment of the present disclosure. As above, the device for disposal of waste material 100 may include the handle 110 which may include a telescoping member 111 with a lock 112 which secures the handle 110 in an extended position and alternately collapses for compact storage. The handle 110 may also incorporate a grip 115 that may include grooves 116 to allow for a firm grasp. The handle 110 may ever further include a hinge 113 allowing the handle 110 to pivot away for the catch 130 at least thirty degrees.

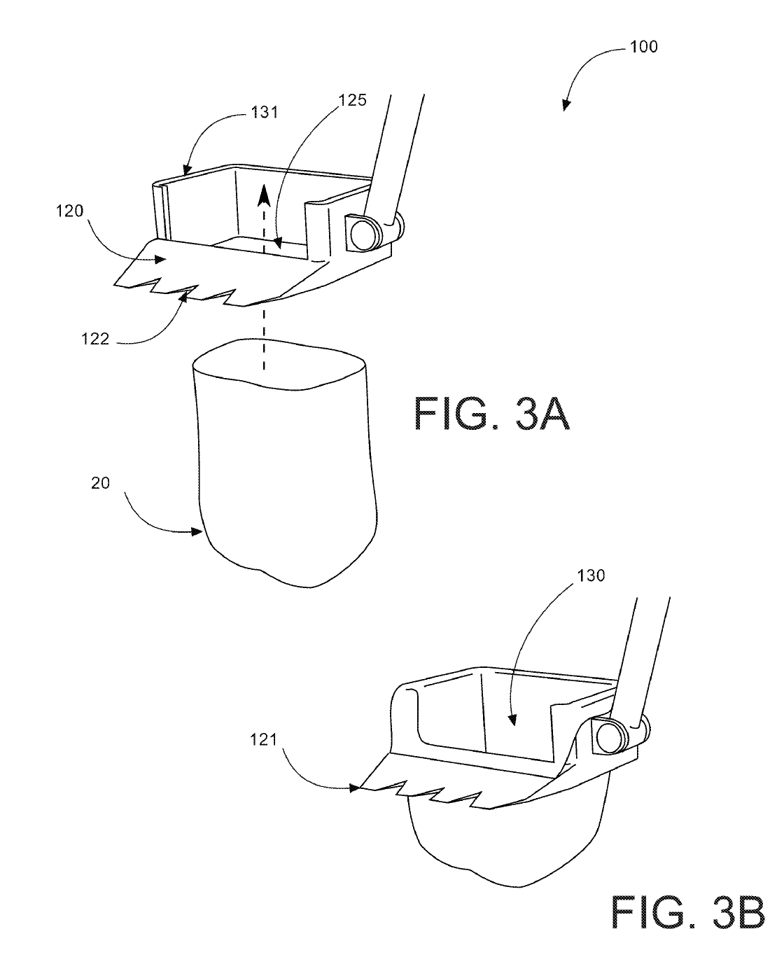

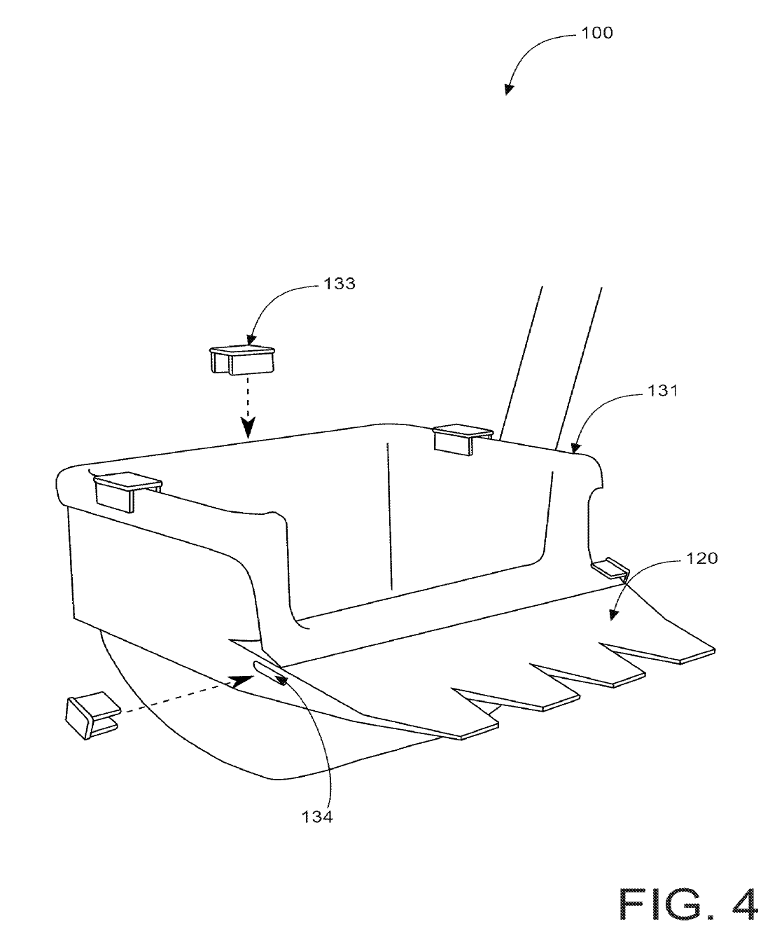

FIG. 3A-3B is a perspective view of the device for disposal of waste material 100 of FIG. 1, according to an embodiment of the present disclosure. As above, the device for disposal of waste material 100 may include the shovel blade 120 that may be coupled to the handle 110 using the hinge 113 so that the handle 110 may pivot thirty degrees form the catch 130. The shovel blade 120 having a scooping edge 121 opposite the catch 130 may include tines 122 to improve the function of the scooping edge 121 when passing through rough terrain. The catch 130 may include a fastening lip 131 configured to receive a disposable waste bag 20, which may then be fastened to the fastening lip 131 of the catch 130 with a set of fastening clips 133 (FIG. 4) that hold the disposable waste bag 20 in place. The shovel blade 120 may also include at least two fastening clip apertures 134 which are useful for securing the set fastening clip 133 in place, which hold the disposable waste bag 20 securely to the scooping edge 121.

FIG. 4 is a perspective view of the device for disposal of waste material of FIG. 1, according to an embodiment of the present disclosure. The disposable waste bag 20 may be inserted through a center aperture 125 and may be secured along a fastening lip 131 using the set of fastening clips 133. Alternately, other attaching means may be used.

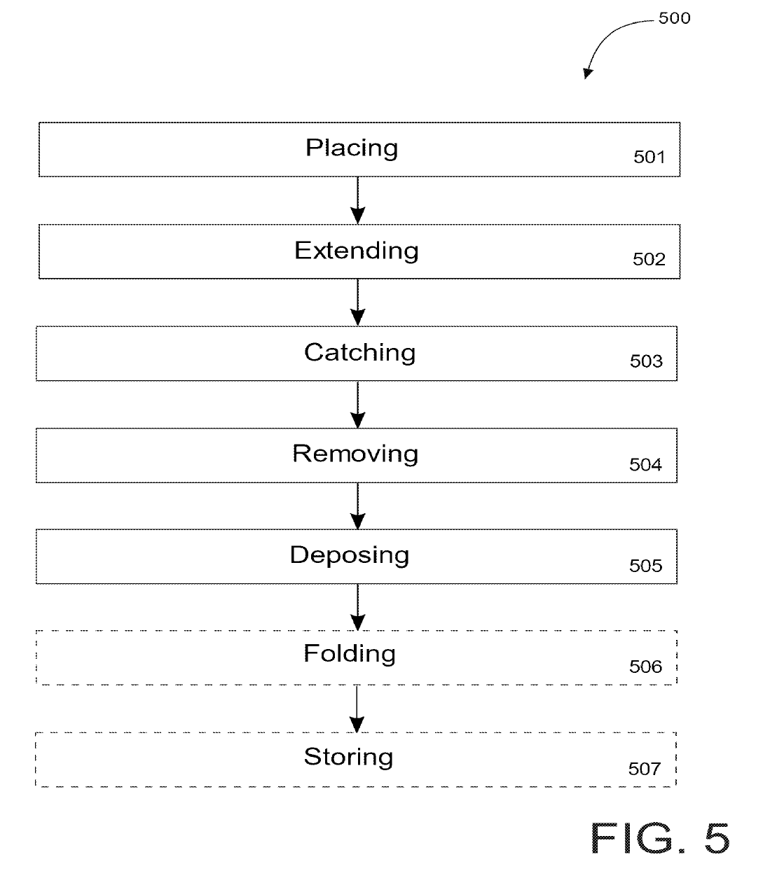

FIG. 5 is a flow diagram illustrating a method for using 500 the pet waste removal system for the disposal of waste material 100, according to an embodiment of the present disclosure. In particular, the method for using 500 the pet waste removal system for the disposal of waste material 100 may include one or more components or features of the device for disposal of waste material 100 as described above. As illustrated, the method for using 500 the pet waste removal system for the disposal of waste material 100 may include the steps of: step one 501, placing a disposable bag in the device; step two 502, extending the device; step three 503, catching waste material; step four 504, removing disposable bag from device; step five 505, deposing of used disposable bag; step six 506, folding the device; and step seven 507, storing the device.

It should be noted that step 506-507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using the pet waste removal system for the disposal of waste material (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for disposal of waste material, the device comprising:
a handle having a grip,
a shovel blade coupled to the handle, the shovel blade including a scooping edge and a center aperture, the shovel blade configured to direct the waste material from the scooping edge through the center aperture when scooped; and
a catch coupled to the center aperture, the catch configured to receive the scooped waste material and retain the scooped waste material when passed through the center aperture.

2. The device of claim 1, wherein the handle includes a telescoping member.

3. The device of claim 2, wherein the telescoping member includes a lock configured to secure the telescoping handle in an extended position.

4. The device of claim 2, wherein the telescoping member is collapsible into a stowed configuration.

5. The device of claim 1, wherein the catch includes a disposable bag configure to attach to the shovel blade.

6. The device of claim 5, wherein the shovel blade includes a back wall opposite the scooping edge and at least partially around the center aperture; and
wherein the disposable bag is further configured to removably attach to the back wall.

7. The device of claim 6, wherein the back wall includes a fastening lip configured to hold open and secure the disposable bag to the device during use.

8. The device of claim 7, further comprising a plurality of bag clips configured to clip the disposable bag to the fastening lip.

9. The device of claim 7, further comprising an elastic band configured to secure the disposable bag to the fastening lip.

10. The device of claim 1, wherein the handle and the shovel blade are pivotably coupled together.

11. The device of claim 2, wherein the handle tilts back thirty degrees.

12. The device of claim 2, wherein the handle includes a hinge pivotably coupling to the catch.

13. The device of claim 12, wherein the hinge is parallel to the catch permitting the telescoping handle to move backward and alternatively forward in relation to the shovel blade.

14. The device of claim 5, wherein the shovel blade includes tines.

15. The device of claim 14, wherein the tines are configured to help scoop debris into the catch.

16. The device of claim 1, wherein the grip includes finger grooves configured to allow the user to grasp firmly.

17. A device for disposal of waste material, the device comprising:
a handle having a grip,
wherein the grip includes finger grooves configured to allow the user to grasp firmly,
a shovel blade coupled to the handle, wherein the handle includes a hinge pivotably coupling to the catch, wherein the handle tilts back thirty degrees, and wherein the hinge is parallel to the catch permitting the telescoping handle to move backward and alternatively forward in relation to the shovel blade, and wherein the handle includes a telescoping member, wherein the telescoping member includes a lock configured to secure the telescoping handle in an extended position, wherein the telescoping member is collapsible into a stowed configuration, the shovel blade including a scooping edge with a ramped portion; and
a center aperture, wherein the shovel blade includes a back wall, wherein the back wall includes a fastening lip, further comprising a plurality of bag clips configured to clip the disposable bag to the fastening lip, and configured to hold open and secure a disposable bag to the device during use opposite the scooping edge, and at least partially around the center aperture, and wherein the disposable bag is further configured to removably attach to the back wall, the shovel blade configured to direct the waste material from the scooping edge through the center aperture when scooped; and
a catch coupled to the center aperture, wherein the catch includes the disposable bag configured to attach to the shovel blade, wherein the shovel blade includes tines configured to help scoop debris into the catch, and configured to receive the scooped waste material and retain the scooped waste material when passed through the center aperture.

18. The device of claim 17, further comprising set of instructions; and
wherein the device is arranged as a kit.

19. A method of using the pet waste removal system for the disposal of waste material, the method comprising the steps of:
placing a disposable bag in the device;
extending the device;
catching waste material;
removing disposable bag from device; and
deposing of used disposable bag.

20. The method of claim 19, further comprising the steps of:
folding the device; and
storing the device.
